(19) United States
(12) Patent Application Publication
(10) Pub. No.: US 2023/0104455 A1
(43) Pub. Date: Apr. 6, 2023

(54) PROCESSING AND VISUALIZATION OF PREDICTED AIRCRAFT TRAJECTORIES AND ESTIMATED TIME OF ARRIVAL PERFORMANCE

(71) Applicant: The MITRE Corporation, McLean, VA (US)

(72) Inventors: Brock J. Lascara, Charlottesville, VA (US); John Miller Timberlake, III, Arlington, VA (US); Lesley A. Weitz, Vienna, VA (US); Mitch Wynnyk, McLean, VA (US)

(21) Appl. No.: 17/493,395

(22) Filed: Oct. 4, 2021

(51) Int. Cl. G08G 5/00; B64D 45/00; B64D 43/00

(52) U.S. Cl. CPC G08G 5/0043; G08G 5/0013; B64D 45/00; B64D 43/00

(57) ABSTRACT

Disclosed herein are system, method, and computer program product embodiments for evaluating accuracy of estimated time of arrival predictions by an air traffic management tool for scheduling aircraft. Evaluation may include comparing predicted trajectories across any number of flights with actual trajectories to determine estimate time of arrival errors and statistics. Evaluation may further involve a visualization system that includes processing flight data into a visualization format and providing a graphical user interface for interacting with the predicted and actual trajectories. The graphical user interface provides an interactive display for manipulating the predicted and actual trajectories on an individual flight basis or across flights.

### STATEMENT REGARDING FEDERALLY-SPONSORED RESEARCH AND DEVELOPMENT

The U.S. government has a paid-up license in this invention and the right in limited circumstances to require the patent owner to license others on reasonable terms as provided for by the terms of Contract No. DTFAWA-10-C-00080 awarded by the Federal Aviation Administration.

### BACKGROUND

### Field

The present disclosure generally relates to processing and providing visualization of an estimated time of arrival (ETA) log file and evaluating the accuracy of the ETA data within the log file.

### Background

ETA accuracy is vital for aviation systems that provide scheduling or operational decision support. These aviation systems, such as the Time-Based Flow Management (TBFM) system, provide scheduling and Decision Support Tool (DST) functionality to support Air Traffic Control (ATC) in performing Time-Based Management (TBM) operations. In particular, aviation systems may be used to help air traffic controllers manage the flow of aircraft as planes ascend to and descend from their cruising altitudes into the busy terminal airspace near an airport. To provide this support, aviation systems use trajectory modeling functions to estimate flight times to different points in the airspace. Sequences and Scheduled Times of Arrival (STAs) of aircraft at specified constraint points (or meter points) are determined from the estimated flight times. Information is provided to help ATC manage individual flights to their STAs, which supports the overall management of arrival flows into congested terminal airspace.

Both the schedule and the information provided to ATC to manage a flight to its STAs rely on the aviation system's calculation of the aircraft's estimated time of arrival (ETA). The ETA is a prediction of the aircraft's arrival time at a meter point. ETA accuracy is a measure of how closely a system's estimated arrival time is to the actual arrival time.

Operational performance is directly related to ETA accuracy, so quantifying and visualizing ETA accuracy is important. Less accurate ETA calculations can lead to inefficient aviation system operations. Conversely, more accurate ETAs increase effectiveness of ATC operations, requiring fewer corrective actions by controllers and resulting in better delivery accuracy at meter points. Accordingly, there exists a need to provide ways to quantify and visualize ETA accuracy and trajectory-prediction performance.

### SUMMARY

The present disclosure describes a novel approach for quantifying and visualizing ETA accuracy and trajectory-prediction performance to ensure aviation system performance supports TBM objectives. The approach evaluates ETA errors and enables a more in-depth understanding of aviation system behaviors through visualizations of trajectory predictions and associated flight data.

Provided herein are method, apparatus, and/or computer program product embodiments, and/or combinations and sub-combinations thereof, for implementing this novel approach. In a non-limiting embodiment, a method for evaluating a predicted trajectory associated with a flight based on an estimated time of arrival log file includes generating the ETA log file from the aviation system or the functions within the aviation system related to ETA generation. The ETA generation system may be generating ETAs for operational flights or generating ETAs for simulated test data played back through the ETA generation logic. Operational and simulated flight data includes flight parameters such as position, wind, ground speed, aircraft type, just to name a few examples. The ETA log file comprises at least one predicted trajectory and ETA prediction to a flight point. When generated, the predicted trajectory is based on aircraft state data and flight plan data. The aircraft state data may include at least one position of the flight of interest, which may include at least one of simulated flights and historical flights, an altitude of the flight of interest, a groundspeed of the flight of interest, and the flight plan data may include the expected route of flight. In some embodiments, the aircraft state data may be used to define a reference trajectory. In other embodiments, the reference trajectory may be defined when data of the aircraft state data (e.g., aircraft position, altitude, and groundspeed) is provided in sequence.

The method may further include extracting aircraft state data and ETA data from the ETA log file and computing ETA error data based on the aircraft state data, comprising the reference trajectory (of an operational or simulated flight), and the ETA data to selected points in the airspace. In some embodiments, the aircraft state data may be timestamped and/or sequentially ordered. The method may further include displaying, via a graphical user interface, the predicted trajectory (or trajectories), the ETA error data, and the reference trajectory of the flight of interest.

Further features and exemplary aspects of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate the embodiments and, together with the description, further serve to explain the principles of the embodiments and to enable a person skilled in the relevant art(s) to make and use the embodiments.

FIG. 1 illustrates an overview of an example implementation of the visualization process, according to some embodiments.

FIG. 2 illustrates an example visualizer for generating a visualization of collected flight data based on an estimated time of arrival log file, according to some embodiments.

FIG. 3 illustrates an example ETA log file, according to some embodiments.

FIG. 4 illustrates a flow diagram for generating a visualization based on an ETA log file, according to some embodiments.

FIG. 5 illustrates a flow diagram for parsing an ETA log file, according to some embodiments.

FIG. 6 illustrates a flow diagram for processing ETA parameters in an ETA log file, according to some embodiments.

FIG. 7 illustrates an example visualization of predicted trajectories based on processing the ETA parameters in an ETA log file.

FIG. 8 illustrates an example visualization of ground track, predicted trajectory data, and waypoint data based on processing the ETA parameters in an ETA log file, according to some embodiments.

FIG. 9 illustrates an example visualization of ETA errors based on processing the ETA parameters in an ETA log file.

FIG. 10 is an example computer system useful for implementing various embodiments.

The features and exemplary aspects of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The embodiment(s) described, and references in the specification to “one embodiment,” “some embodiments,” “an example embodiment,” “some embodiments,” etc., indicate that the embodiment(s) described may include a particular feature, structure, and/or characteristic, but every embodiment may not necessarily include the particular feature, structure, and/or characteristic. Moreover, such phrases are not necessarily referring to the same embodiment. Further, when a particular feature, structure, and/or characteristic is described in connection with some embodiments, it is understood that it is within the knowledge of one skilled in the art(s) to effect such feature, structure, and/or characteristic in connection with other embodiments whether or not explicitly described. The scope of this disclosure is not limited to the disclosed embodiment(s), but is instead defined by the claims appended hereto.

The term “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value).

Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM), random access memory (RAM), magnetic disk storage media, optical storage media, flash memory devices, and/or electrical, optical, acoustic, or other forms of propagated signals (e.g., carrier waves, infrared signals, digital signals, etc.), and others. Further, firmware, software, routines, and/or instructions may be described herein as performing certain actions. However, it should be appreciated that such descriptions are merely for convenience and that such actions in fact result from computing devices, processors, controllers, and/or other devices executing the firmware, software, routines, instructions, etc.

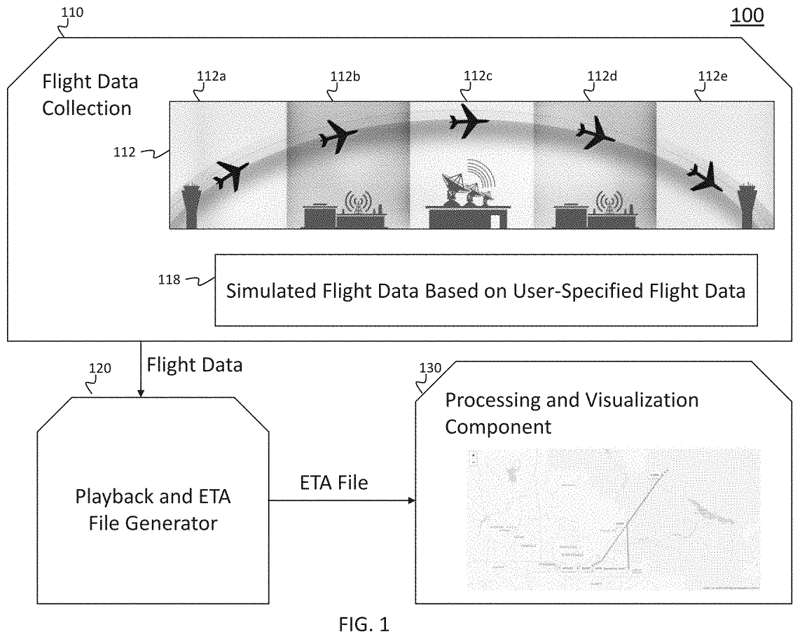

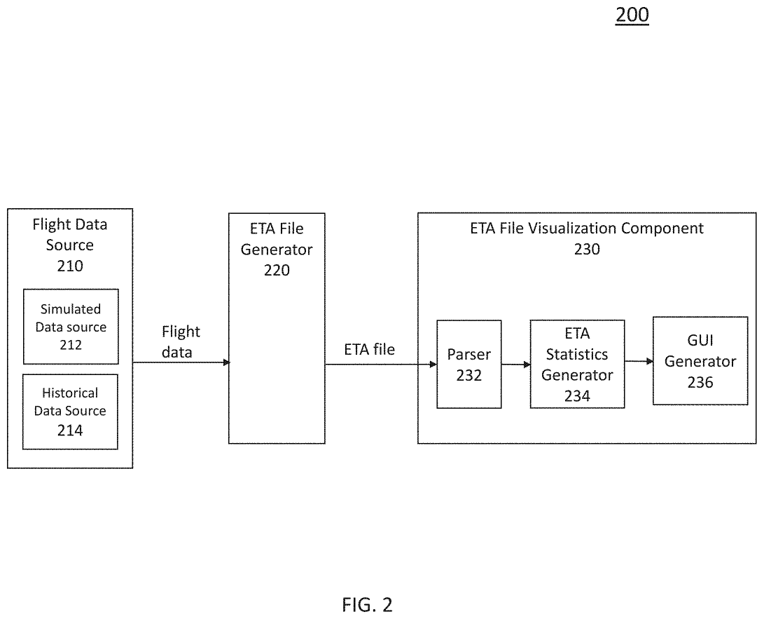

FIG. 1 is a diagram of an overview of an example visualization system 100 in which features described in this disclosure may be implemented. As described herein, system 100 merely provides a general discussion of features for generating a visualization of estimated time of arrival information for one or more flights based on historical flight data or simulated flights based on user-specified flight data. More details of the process and the interactive visualization are discussed with respect to FIGS. 2-9 below. In some embodiments, flight data may be implemented using any one of the aircraft state data and a flight plan.

Example visualization system 100 may be implemented to evaluate estimated time of arrival information provided by an aviation system that relies on ETA data for operational decisions. In an embodiment, the aviation system may be a Time-Based Flow Management system. An aviation system provides scheduling and Decision Support Tool functionality, such as flight prediction and scheduling functionality, to support Air Traffic Control in performing Time-Based Management operations for flights. The aviation system uses trajectory modeling functions to estimate flight times to different points in the airspace. Flight-time estimation, and specifically ETA information, is a critical component of flight scheduling and management and example visualization system 100 provides a means for determining the accuracy of ETA information as calculated by the aviation system.

Advantages of example visualization system include supporting engineering development and to perform software-level regression testing to evaluate ETA accuracy performance, software acceptance testing before accepting the software from an aviation system vendor, adaptation-level testing to validate that a given site-specific adaptation of the aviation system is producing operationally-acceptable ETA errors, site-report analysis to explore the extent to which ETA errors contributed to a site report, and researching future design changes for improving the aviation system.

As shown in FIG. 1, example visualization system 100 may include flight data collection 110 that collects stored flight data which may include historical flight data 112 and simulated flight data based on user-specified flight data 118. Stored flight data may refer to any flight data associated with either an actual flight that occurred or a simulated flight (e.g., from a simulator based on user-specified flight data 118). Historical flight data 112 may include data from actual flights collected at different stages 112a-112e of the flights. For example, stage 112a may represent initial departure when the aircraft is in terminal airspace; stage 112b may represent climb through en route airspace to a cruise altitude; stage 112c may represent the cruise phase of flight in en route airspace; stage 112d may represent the initial descent from cruise altitude while in en route airspace; and, stage 112e may represent the arrival and approach phase of flight in terminal airspace.

Historical flight data 112 allows for evaluation of ETA behaviors at a given site when flights are subject to actual wind conditions, unmodeled aircraft dynamics (and therefore unable to be simulated by the aviation system), and air traffic control interventions (e.g., speed changes or off-path deviations).

Simulated flight data based on user-specified flight data 118 represents flight data generated by a flight simulator or a trajectory generation and flight model. Example considerations for simulating flight data includes using a flight model that reasonably represents aircraft flight dynamics; using flight paths that adhere to navigation procedures, including procedural speed and altitude constraints and path navigation constraints; using flight plans that reasonably represent historic operations; using wind conditions that reasonably represent historical conditions; and, allowing for user-specified parameters of the flight plans (e.g., route of flight including any published navigation procedures), aircraft types, cruise altitudes, cruise speeds, and climb and/or descent speeds.

Simulated flight data based on user-specified flight data 118 provides different advantages over historical flight data 112 when generating a visualization because specific conditions may be controlled and tested. Simulated flight data based on user-specified flight data 118 refers to flight parameters that are specified by a user and are not necessarily associated with an actual flight. As an example, a user may specify wind conditions. Other examples of user-specified flight data include aircraft type and cruise altitude, just to name a few examples. Control over the specific flight parameters allows for verification of software performance or to quantify ETA accuracy for a site-specific application of the aviation system. With control over the aircraft states, some ETA error sources can be controlled and minimized allowing the analyst to focus on specific error sources or core trajectory-prediction logic and assumptions in the aviation system.

Simulated flight data based on user-specified flight data 118 allows a user to design controlled scenarios for evaluating specific populations of flights. One example of a controlled scenario is to create tracks that follow a “nominal arrival flow” to evaluate the ETA performance against an ETA accuracy requirement, which specifies the required performance of the aviation system. Nominal flows include a range of aircraft types, with varying cruise altitudes, cruise speeds, and climb and/or descent speeds, to represent typical operations at a selected facility.

Simulated flight data based on user-specified flight data 118 could be used for a focused analysis of particular parameters. For example, the aviation system ETA performance for a given aircraft type could be evaluated. In that case, scenarios could be designed with a single aircraft type with varying cruise altitudes, cruise speeds, and climb and/or descent speeds. As another example, the aviation system ETA performance across wind conditions may also be studied by evaluating the same aircraft set (i.e., aircraft type, cruise altitude, cruise speed, and climb and/or descent speed) in different wind conditions.

Flight data from flight data collection 110 is provided to Playback and ETA file Generator 120 for generating a log file. Playback and ETA file generator 120 first performs a replay of the flight data to generate predicted trajectory data and ETA data. This data is output to the ETA log file. The ETA log file includes the predicted trajectories that are generated based on the flight data. In some embodiments, the predicted trajectory may be based on the flight route and the aircraft state data and may be utilized to determine a predicted crossing time associated with the inputted aircraft state data. The predicted trajectories may include ETA information. The data in the ETA log file contains the information needed to assess ETA accuracy performance of the aviation system.

In an embodiment, Playback and ETA File Generator 120 generates a predicted trajectory for each flight from which ETAs to selected points, like an arrival flow entry point or the runway, are determined. ETAs may be used to determine STAs at those selected points. Regarding waypoints, Playback and ETA File generator 120 may determine a sequence of waypoints that inform trajectory construction based on flight plan information and track position and stores this information in the ETA log file. Waypoint information includes waypoint names, waypoint coordinates, and any speed or altitude constraints at each waypoint. Meter points may be considered a single point or as a meter arc through which flights pass.

Visualization component 130 receives the ETA log file from Playback and ETA File generator 120. Visualization component 130 analyzes the ETA log file including the predicted trajectories for each flight represented in the flight data, computes ETA accuracy statistics based on the analysis, and generates a visualization of the ETA accuracy statistics. In an embodiment, a visualization component 130 may be implemented as a user-interactive browser-based application that parses the ETA log file and provides visualization of flight behaviors and ETA performance in the form of interactive graphs and tables.

FIG. 2 illustrates an example visualization system 200 for generating a visualization of collected flight data, according to some embodiments. In an embodiment, visualization system 200 includes flight data source 210, ETA file generator 220, and ETA file visualization component 230. Flight data source 210 may include simulated data source 212 and historical data source 214. Simulated data source 212 may include a tool to specify flight plan information and wind information as parameters for generating the simulated flight data. In an embodiment, the simulated flight data includes aircraft state data (e.g., latitude, longitude, altitude, groundspeed, and time) and flight plan data. Historical data source 214 may include a tool to extract stored flight plan information and stored aircraft states provided from actual flights.

ETA file generator 220 receives the stored flight data (e.g., aircraft state, flight plan) associated with a stored flight from flight data source 210. ETA file generator 220 replays the stored flight data (historical and/or simulated) for each flight and generates predicted trajectories for each flight based on the flight data. Replaying the stored flight data may include using any data associated with a stored flight such as aircraft state data (e.g., time, position, altitude, and speed) and waypoint information to generate a predicted (i.e., expected) trajectory of the flight. The predicted trajectories include predicted aircraft positions and crossing times with respect to waypoints and meter points along the predicted trajectories. The predicted trajectories for each flight may be stored in an ETA log file.

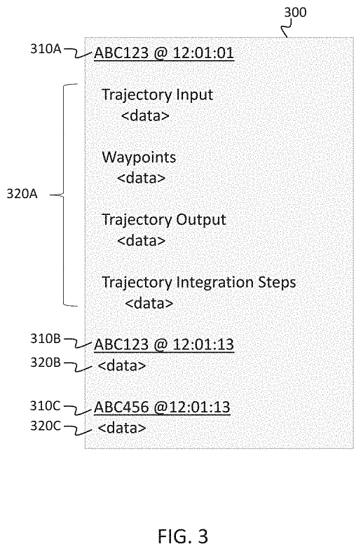

FIG. 3 illustrates an exemplary ETA log file 300 which includes predicted trajectory data about different flights at different points in time. ETA log file 300 includes three flight entries associated with flight identifiers 310A-310C at particular points in time. It is understood that an ETA log file may contain any number of flight entries associated with any number of different flights. A flight (represented by a flight number, e.g., ABC123) may be associated with any number of flight entries.

ETA log file 300 includes flight identifier 310A identifying the flight number (e.g., ABC123) at time 12:01:01. Flight identifier 310A is associated with trajectory information 320A for the flight at that time. Trajectory information 320A may include trajectory input data, waypoint data, trajectory output data, and trajectory integration steps (TIS).

Trajectory input data is the aircraft state data that may be used to construct a predicted trajectory and includes, among other things, aircraft identifier, aircraft type, current position, current altitude, current speed, and time. Waypoint data includes waypoint names, waypoint coordinates, and any speed or altitude constraints at each waypoint. A sequence of waypoints including the relevant waypoint data further inform the construction of predicted trajectories based on flight plan data and aircraft state data. Trajectory output data includes the predicted trajectory and ETA to the final waypoint in the waypoint data and a textual trajectory description.

TIS refers to the intermediate segments, between the initial and end points, that are integrated together to describe a detailed predicted trajectory. For each aircraft crossing a meter point, a four-dimensional (4D) trajectory is generated that predicts the aircraft's three-dimensional (3D) position as a function of time, starting from its current position to the meter point. TIS includes trajectory information (e.g., latitude, longitude, altitude, time, along-path distance, speed, and wind) at each integrated segment along the trajectory. In an embodiment, a predicted groundspeed may also be integrated along the predicted trajectory to estimate the time the aircraft will cross the meter point. The estimated time of arrival that the aircraft will cross the meter point is the ETA. A new predicted trajectory may be generated based on certain trigger events such as an aircraft state update.

ETA log file 300 may also include trajectory data associated with the same flight but at different times. For example, flight identifier 310B refers to the same flight number (e.g., ABC123) but at a different point in time, 12:01:13. Trajectory information 320B includes updated trajectory input data, waypoint data, trajectory output data, and trajectory integration steps based on any changes to the flight's aircraft state data at the different point in time.

ETA log file 300 may also include trajectory data associated with different flights. For example, flight identifier 310C refers to a different flight number (e.g., ABC456) at time 12:01:13. Trajectory information 320C may include trajectory input data, waypoint data, trajectory output data, and trajectory integration steps for that flight.

In some embodiments, ETA log file 300 organizes trajectory information 320A-C in a semi-structured, non-tabular format.

Returning to FIG. 2, ETA file visualization component 230 may include parser 232, statistics generator 234, and Graphical User Interface (GUI) generator 236. Parser 232 receives the ETA log file from ETA File Generator 220. Parser 232 parses the ETA log file to extract relevant flight data and prepares the extracted flight data for further processing by statistics generator 234. In an embodiment, parser 232 performs a full indexing of the ETA log file which involves reading parameters from the ETA log file into local memory. Parser 232 may organize the extracted data into categorized datasets including trajectory input data, waypoint data, TIS, and ETA accuracy results. ETA accuracy results include any ETA errors that may be represented by the difference between the ETA at the waypoints and the actual time the aircraft crosses the waypoint. These ETA errors may be generated for each predicted trajectory included in the ETA log file.

Parser 232 may further load the stored parameters into a field separated container (e.g., comma-separated values (CSV) file) which can be organized into a tabular format. As part of the loading process, parser 232 may further associate waypoint data and TIS data with each flight using a unique flight identifier. A field separated container such as a CSV file has advantages over unstructured files such as the ETA log file because field separated containers can more easily be displayed in tabular views and more easily processed by other analytic tools because the tabular format is more widely accepted by software applications.

Parser 232 may further perform additional processing on the waypoint data and the TIS data. In an embodiment, waypoint data may be initially implemented as x-y coordinates and parser 232 may convert the waypoint data from x-y coordinates to a corresponding latitude and longitude. A final waypoint of the predicted trajectory may be identified based on the corresponding latitude and longitude information. In an embodiment, TIS data may also be initially implemented as x-y coordinates and parser 232 may convert the TIS data to a corresponding latitude and longitude.

ETA statistics generator 234 processes, for each flight identifier, the stored parameters in the field separated container. The purpose of ETA statistics generator 234 is to compute the ETA error for each waypoint. As noted above, ETA error refers to a comparison between the estimated crossing time at the waypoint versus the actual crossing time at the waypoint (which may be retrieved from the reference trajectory). In some embodiments, the actual crossing time may be calculated based on the aircraft state data and/or the reference trajectory that is defined based on the aircraft state data (when the data is provided in sequence). The reference trajectory may be the actual trajectory of a historical flight or a simulated trajectory. The estimated crossing time is derived from the predicted trajectories that were generated as part of the replay of the flight data by playback processor 222. ETA statistics generator identifies waypoints across trajectories for each flight and computes the ETA error for each of these waypoints. ETA statistics generator also computes aggregate statistics for each flight such as the average and standard deviation of ETA errors for the flight.

GUI generator 236 generates the visualization based on the ETA error provided by ETA statistic generator 234, the predicted flight data (such as the predicted trajectory), and the reference flight data (such as reference trajectory and actual crossing time). Visualizations (e.g., graphs) may include tabular view of the predicted flight data, a visualization of the predicted trajectory versus the reference trajectory, a visualization of the ETA error, just to name a few examples. As an example of visualizing predicted trajectories, predicted trajectories may be compared to the aircraft state data input for each flight, comprising the reference trajectory, using plots of the horizontal path, altitude profile, and speed profile (in calibrated airspeed or ground speed).

In an embodiment, as new predicted trajectories are generated for each aircraft state data input, a slider bar may enable the examination of the evolution of the predicted trajectories as the flight progresses. The slider bar feature allows the user to easily correlate any sudden or unexpected changes in the ETA with predicted-trajectory behaviors. This visualization therefore eases ETA error evaluation and troubleshooting.

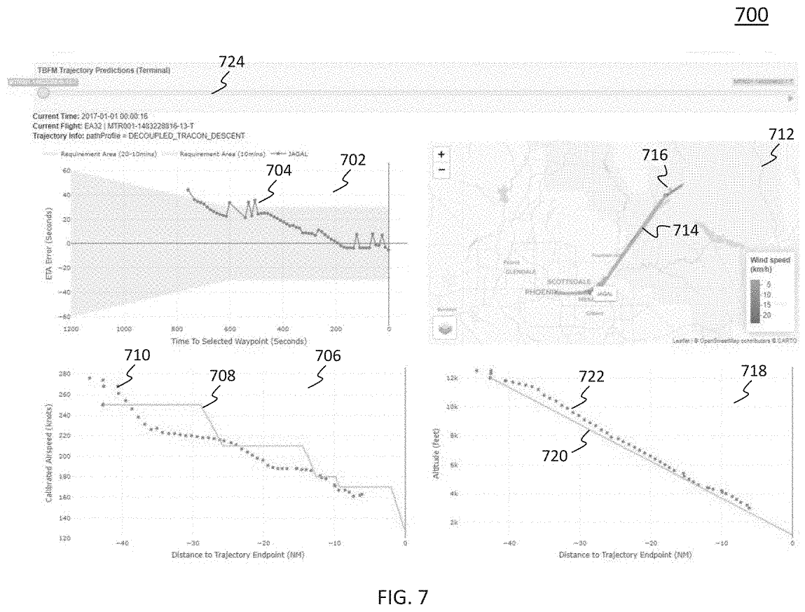

Additional advantages of the visualization provided by GUI generator 236 are discussed in further detail with respect to FIGS. 7-9, below.

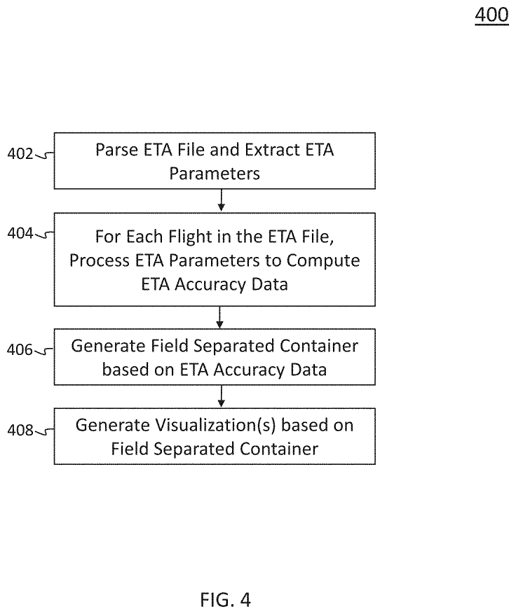

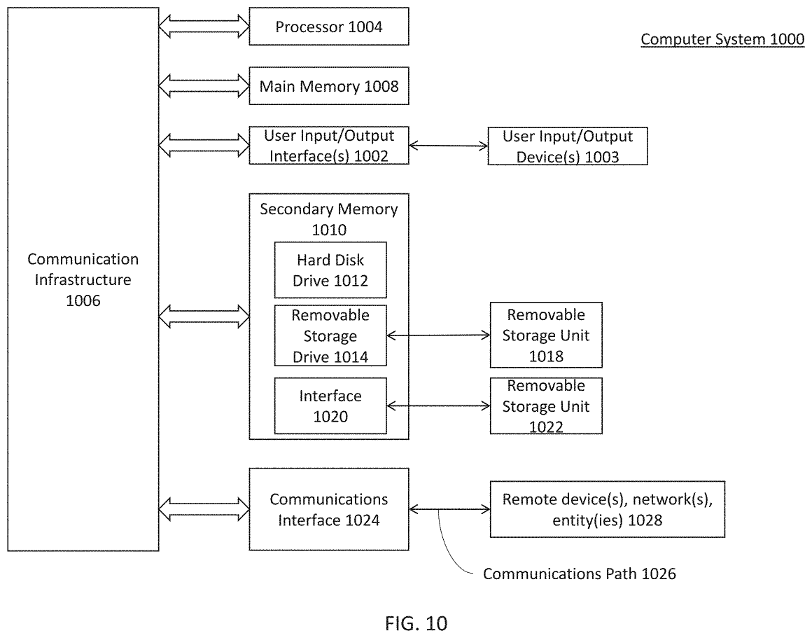

FIG. 4 illustrates a flow diagram for generating a visualization based on an estimated time of arrival (ETA) file, according to some embodiments. As a non-limiting example with regards to FIG. 4, one or more processes described with respect to FIG. 4 may be performed by a visualization system (e.g., visualization system 200 of FIG. 2) to generate a visualization based on an ETA log file. In such an embodiment, visualization system 200 may execute code in memory to perform certain steps of method 400 (e.g., UNIX commands). While method 400 will be discussed below as being performed by visualization system 200, other devices may store the code and therefore may execute method 400 by directly executing the code. Accordingly, the following discussion of method 400 refers to FIG. 2 merely as an exemplary non-limiting implementation of method 400. For example, method 400 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof. Moreover, it is to be appreciated that not all steps may be needed to perform the disclosure provided herein. Further, some of the steps may be performed simultaneously or in a different order than shown in FIG. 4, as will be understood by a person of ordinary skill in the art.

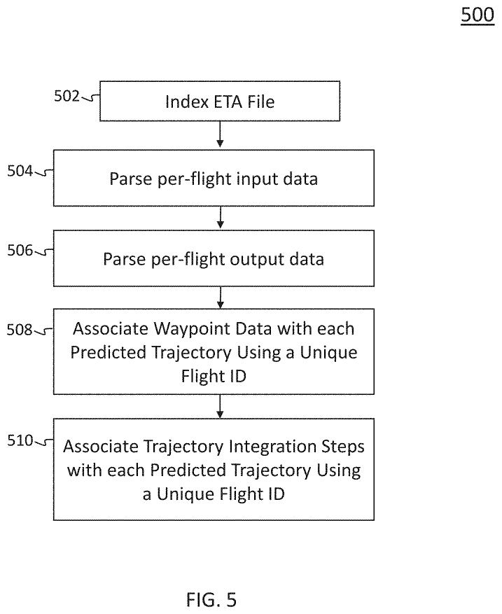

In 402, parser 232 receives an ETA log file that includes predicted trajectories of flights based on historical and/or simulated flight data. Flight data may include information about aircraft state data such as latitude, longitude, altitude, groundspeed, and time, as well as flight plan data such as flight plan route and aircraft type. Flight data may be associated with a stored flight which may include an actual flight or a simulated flight. Historical flight data may refer to flight data collected from actual flights while simulated flight data may refer to flight data collected from one or more simulated flights. A simulated flight may be simulated based on user-supplied flight data. In an embodiment, the ETA log file generated by a TBFM system but any system that generates ETA information may be utilized. Parser 232 parses the ETA log file that recorded trajectory information as part of replaying historical and/or simulated flight data by playback processor 222. The data needed for ETA error evaluation, such as trajectory input data, trajectory output data, waypoint data, and TIS data, are extracted from the ETA log file. As noted above, ETA data represent data associated with predicted trajectories for flights through various meter points during the flight. The purpose of the parsing step is to retrieve the data from the ETA log file and load them into local memory for additional processing so that the visualizations may be generated to represent the predicted trajectories and actual trajectories of the flights. Method 500 of FIG. 5 discusses parsing the ETA log file in additional detail.

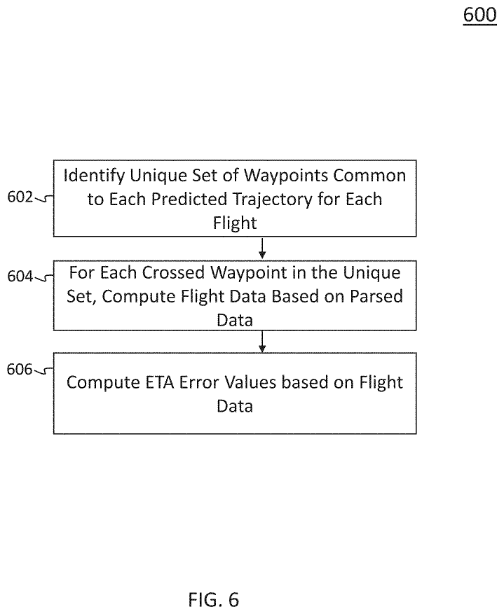

In 404, for each flight entry in the ETA log file, ETA statistics generator 234 may process the extracted ETA parameters in order to compute ETA accuracy data including actual crossing times (from the reference trajectory for each flight) for each waypoint and associated ETA errors. Method 600 of FIG. 6 discusses processing the extracted ETA data in additional detail.

In 406, ETA statistics generator 234 generates a field separated container and loads the container with the ETA accuracy data generated during 404.

In 408, GUI generator 236 generates visualization(s) based on the data in the field separated container. Example visualizations are discussed respect to FIGS. 7-9, below.

FIG. 5 illustrates a flow diagram for parsing the ETA log file, according to some embodiments. As a non-limiting example with regards to FIG. 5, one or more processes described with respect to FIG. 5 may be performed by a visualization system (e.g., visualization system 200 of FIG. 2) to parse the ETA log file. In such an embodiment, visualization system 200 may execute code in memory to perform certain steps of method 500 (e.g., UNIX commands). While method 500 will be discussed below as being performed by visualization system 200, other devices may store the code and therefore may execute method 500 by directly executing the code. Accordingly, the following discussion of method 500 refers to FIG. 2 merely as an exemplary non-limiting implementation of method 500. For example, method 500 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof. Moreover, it is to be appreciated that not all steps may be needed to perform the disclosure provided herein. Further, some of the steps may be performed simultaneously or in a different order than shown in FIG. 5, as will be understood by a person of ordinary skill in the art.

In 502, parser 232 indexes the ETA log file which includes reading flight data from the ETA log file and loading the flight data into local memory. Examples of flight data include trajectory input data, flight times, waypoint data, trajectory output data, and TIS data. Examples of trajectory input data include aircraft identifiers and line numbers within the ETA log file where the trajectory input data may be located. Flight times may be represented by timestamps. Waypoint data may include the number of waypoints in a predicted trajectory and line numbers within the ETA log file where the waypoint data may be located. Trajectory output data may include the line numbers within the ETA log file where the trajectory output data may be found. Examples of TIS data include the number of TIS lines within the ETA log file and the line numbers within the ETA log file where the TIS data may be located.

In an embodiment, parser 232 may employ native UNIX commands (e.g., grep, sed, tr) to perform the indexing of the ETA log file. Native UNIX commands provide the advantage of fast execution speed which improves the efficiency of indexing the ETA log file.

In 504, parser 232 may parse per-flight input data in the ETA log file. Parsing the per-flight input data may include loading the input data directly into a field separated container for later processing.

In 506, parser 232 may process per-flight output data in the ETA log file. Parsing the per-flight output data may include loading the output data directly into the field separated container for later processing.

In 508, parser 232 may parse waypoint data and associate the parsed waypoint data with each predicted trajectory using a unique flight identifier. The purpose of this step is to organize the waypoint data for each predicted trajectory (which is informed by the waypoints) based on the particular flight associated with that predicted trajectory. The waypoint data may then be loaded into the field separated container and associated with the unique flight identifier within the container. In an embodiment, additional processing of the waypoint data may occur prior to loading into the container. Additional processing may include converting the x- and y-coordinate information of waypoint data into latitude and longitude information and additionally loading the converted latitude and longitude information associated with the waypoint data into the container.

In 510, parser 232 may parse TIS data and associate the parsed TIS data with each predicted trajectory using a unique flight identifier. The purpose of this step is to organize the TIS data for each predicted trajectory based on the particular flight associated with that predicted trajectory. The TIS data may then be loaded into the field separated container and associated with the unique flight identifier within the container. In an embodiment, additional processing of the TIS data may occur prior to loading into the container. Additional processing may include converting the x- and y-coordinate information of TIS data into latitude and longitude information and additionally loading the converted latitude and longitude information associated with the TIS data into the container.

FIG. 6 illustrates a flow diagram for processing ETA parameters in the ETA log file, according to some embodiments. As a non-limiting example with regards to FIG. 6, one or more processes described with respect to FIG. 6 may be performed by a visualization system (e.g., visualization system 200 of FIG. 2) to parse the ETA log file. In such an embodiment, visualization system 200 may execute code in memory to perform certain steps of method 600 (e.g., UNIX commands). While method 600 will be discussed below as being performed by visualization system 200, other devices may store the code and therefore may execute method 600 by directly executing the code. Accordingly, the following discussion of method 600 refers to FIG. 2 merely as an exemplary non-limiting implementation of method 600. For example, method 600 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof. Moreover, it is to be appreciated that not all steps may be needed to perform the disclosure provided herein. Further, some of the steps may be performed simultaneously or in a different order than shown in FIG. 6, as will be understood by a person of ordinary skill in the art.

In 602, ETA statistics generator 234 identifies a unique set of waypoints common to each predicted trajectory for each flight. In other words, ETA statistics generator 234 identifies waypoints that were used across all of the predicted trajectories for a particular flight.

In 604, ETA statistics generator 234, for each crossed waypoint within the unique set, computes flight data based on the parsed data loaded into the field separated container. Examples of computed flight data included predicted crossing time (i.e., the time at which the flight is estimated to cross the waypoint) and actual crossing time (based on the aircraft state data that comprises the reference trajectory). The reference trajectory may be the actual trajectory of a historical flight or a simulated trajectory. In an embodiment, this step may be performed in a loop for each predicted trajectory associated with the flight. This computed flight data may then also be loaded into the field separated container and organized for each predicted trajectory of a flight. ETA statistics generator 234 may compute flight data for any number of flights, each with their own number of predicted trajectories.

In 606, ETA statistics generator 234 may compute ETA error values based on the computed flight data, including the predicted crossing times and actual crossing times (based on the aircraft state data that comprises the reference trajectory). The computation of the ETA error value for a waypoint involves a comparison between the predicted crossing time at that waypoint with the actual crossing time The reference trajectory may be from a historical flight or a trajectory associated with a simulated flight. In some embodiments, the reference trajectory may reflect a baseline of comparison to determine the accuracy of the data generated based on data in the ETA log file.

FIG. 7 illustrates an example visualization 700 of predicted trajectories based on processing the ETA parameters in the ETA log file, according to some embodiments. Visualization 700 includes various plots 702, 706, 712, and 718 that visualize the data stored in the field separated container and shows a flight arriving in Phoenix and flying southwest. Plots 702, 706, 712, and 718 are merely exemplary and depict one possible visualization 700. Other plots depicting other types of flight data in addition to a plot that shows ETA error may be displayed within visualization 700 for the purpose of determining causes of ETA error.

Displaying multiple plots depicting different aspects of the flight allow for a thorough examination of possible causes of ETA error for a single flight. Even a small difference in the predicted speed and actual speed could translate into sizeable ETA errors when the aircraft is far from the meter point. Plotting the flight data in a single visualization can help pinpoint which aspect of the trajectory prediction contributes most to an ETA error.

Plot 702 depicts an ETA accuracy plot over the course of the flight to a selected waypoint that depicts the predicted ETA error at various points in time. In an embodiment, the ETA error is measured in seconds and is based on the ETA to the waypoint and the actual crossing time. Line 704 depicts the ETA error at various points in time relative to a selected waypoint. For example, at 600 seconds from the selected waypoint, line 704 depicts an ETA error of approximately 38 seconds between the aviation system-calculated ETA and the actual crossing time.

Plots 706, 712, and 718 depict factors that influence the ETA error depicted in plot 702.

Plot 706 depicts a speed profile of the flight. Line 708 represents the predicted speed of the flight and line 710 represents the actual speed of the flight. Plot 712 depicts a lateral path of the flight as it arrives in Phoenix heading southwest. Line 714 represents the predicted lateral path of the flight and line 716 represents the actual lateral path. Plot 718 depicts an altitude profile of the flight. Line 720 represents the predicted altitude of the flight and line 722 represents the actual altitude of the flight.

Visualization 700 also includes a slider bar 724 that may be used to select a particular point in time during the flight. When a new point in time is selected, plots 702-718 may dynamically update to show the ETA error at that new time and a comparison of the predicted trajectory and other information including the predicted lateral, predicted altitude, and predicted speed profiles with the actual flight profile (i.e., the reference trajectory comprising the reference lateral, reference altitude, and reference speed profiles). The reference trajectory may be a stored trajectory for a historical flight or a simulated flight and may be used as a basis for computing the ETA error.

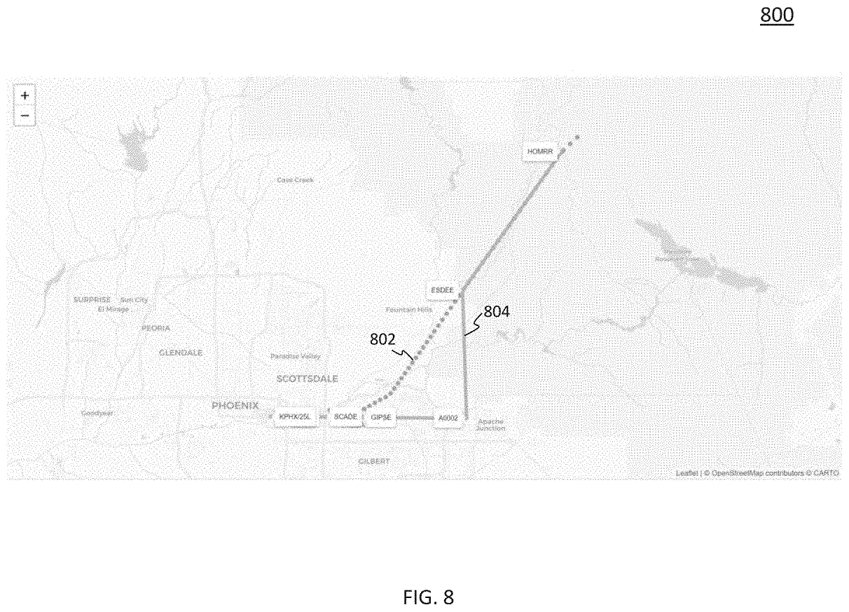

FIG. 8 illustrates an example visualization 800 of waypoint data based on processing the ETA parameters in the ETA log file, according to some embodiments. Visualization 800 provides a geographical view to show the predicted waypoint positions in relation to the reference lateral profile from the reference trajectory of the flight. Line 802 represents the reference ground track while line 804 represents the predicted path based on the aircraft state data (e.g., flight location, altitude, and speed) at the time of prediction and the flight plan. Visualization 800 allows for selection of waypoints on the map which will provide additional information such as information associated with that waypoint. Although not shown, visualization 800 may include a slider bar to see the predicted lateral profile at a particular point in time along the flight. In an embodiment, the predicted trajectory is based on a sequence of waypoints that are determined based on an aircraft's flight plan and its current position from the aircraft state data.

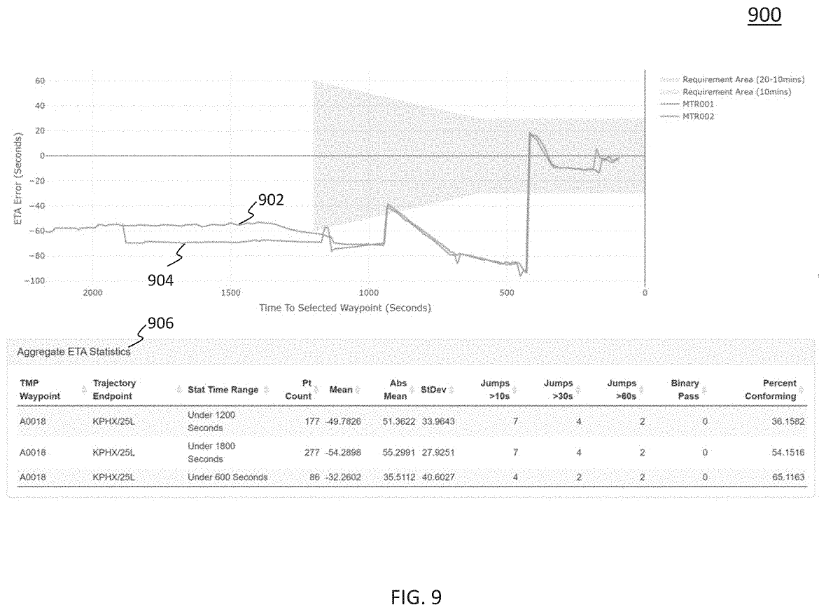

FIG. 9 illustrates an example visualization 900 of ETA errors based on processing the ETA parameters in the ETA log file, according to some embodiments. Visualization 900 represents another embodiment of an ETA accuracy plot (plot 702). Visualization 900 depicts ETA errors for multiple flights. Multiple aircraft can be displayed in the ETA error plot so that the ETA error for each aircraft may viewed at the same time. Line 902 represents the ETA error plot for a first selected aircraft and line 904 represents the ETA error plot for a second selected aircraft. When multiple flights are selected, table 906 depicts aggregated ETA performance statistics across the selected flights.

Various embodiments can be implemented, for example, using one or more computer systems, such as computer system 1000 shown in FIG. 10. Computer system 1000 can be used, for example, to implement method 400 of FIG. 4, method 500 of FIG. 5, and method 600 of FIG. 6. For example, computer system 1000 can determine a resource block allocation of a portion of a tone space using a lookup table. Computer system 1000 can further map a plurality of tones to a resource block based on the determined resource block allocation, according to some embodiments. Computer system 1000 can be any computer capable of performing the functions described herein.

Computer system 1000 can be any well-known computer capable of performing the functions described herein.

Computer system 1000 includes one or more processors (also called central processing units, or CPUs), such as a processor 1004. Processor 1004 is connected to a communication infrastructure or bus 1006.

One or more processors 1004 may each be a graphics processing unit (GPU). In some embodiments, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 also includes user input/output device(s) 1003, such as monitors, keyboards, pointing devices, etc., that communicate with communication infrastructure 1006 through user input/output interface(s) 1002.

Computer system 1000 also includes a main or primary memory 1008, such as random access memory (RAM). Main memory 1008 may include one or more levels of cache. Main memory 1008 has stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 includes a computer usable or readable storage device having stored thereon computer software (control logic) and/or data. Removable storage unit 1018 may be a floppy disk, magnetic tape, compact disk, DVD, optical storage disk, and/ any other computer data storage device. Removable storage drive 1014 reads from and/or writes to removable storage unit 1018 in a well-known manner.

According to an exemplary embodiment, secondary memory 1010 may include other means, instrumentalities or other approaches for allowing computer programs and/or other instructions and/or data to be accessed by computer system 1000. Such means, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 enables computer system 1000 to communicate and interact with any combination of remote devices, remote networks, remote entities, etc. (individually and collectively referenced by reference number 1028). For example, communication interface 1024 may allow computer system 1000 to communicate with remote devices 1028 over communications path 1026, which may be wired and/or wireless, and which may include any combination of LANs, WANs, the Internet, etc. Control logic and/or data may be transmitted to and from computer system 1000 via communication path 1026.

In some embodiments, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

It is to be understood that the phraseology or terminology herein is for the purpose of description and not of limitation, such that the terminology or phraseology of the present specification is to be interpreted by those skilled in the relevant art(s) in light of the teachings herein.

The above examples are illustrative, but not limiting, of the embodiments of this disclosure. Other suitable modifications and adaptations of the variety of conditions and parameters normally in the field, and which would be apparent to those skilled in the relevant art(s), are within the spirit and scope of the disclosure.

While specific embodiments have been described above, it will be appreciated that the embodiments may be practiced otherwise than as described. The description is not intended to limit the scope of the claims.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art(s), readily modify and/or adapt for various applications such specific embodiments, without undue experimentation, without departing from the general concept of the embodiments. Therefore, such adaptations and modifications are intended to be within the meaning and range of equivalents of the disclosed embodiments, based on the teaching and guidance presented herein.

The breadth and scope of the embodiments should not be limited by any of the above-described exemplary embodiments, but should be defined only in accordance with the following claims and their equivalents.

What is claimed is:

1. A method for evaluating a predicted trajectory based on stored flight data in an estimated time of arrival (ETA) log file, comprising:
receiving the ETA log file, wherein the ETA log file includes the stored flight data, wherein the ETA log file comprises the predicted trajectory generated by replaying the stored flight data, wherein the stored flight data is associated with a stored flight, and wherein the predicted trajectory includes aircraft state data and predicted trajectory data;
extracting the aircraft state data and the predicted trajectory data from the ETA log file, wherein the aircraft state data includes at least one of a coordinate position of the stored flight, an altitude of the stored flight, a groundspeed of the stored flight, and wherein the predicted trajectory data comprises at least one of a predicted path, a predicted altitude, and a predicted speed of flight to a future point in the predicted trajectory;
computing ETA error data for the stored flight based on the aircraft state data, the predicted trajectory data, and a reference trajectory of the stored flight; and
displaying, via a graphical user interface, the predicted trajectory, the ETA error data, and the reference trajectory of the stored flight.

2. The method of claim 1, wherein the stored flight data is based on one of historical flight data that is associated with an actual flight or simulated flight data based on user-specified flight data that is associated with a simulated flight and wherein the stored flight is one of the actual flight or the simulated flight.

3. The method of claim 1, wherein the ETA log file further comprises waypoint data associated with a plurality of waypoints in the predicted trajectory and wherein the waypoint data for each waypoint is represented in a coordinate format, the method further comprising:
converting the coordinate format into a corresponding latitude and a corresponding longitude.

4. The method of claim 3, further comprising:
identifying a waypoint in the plurality of waypoints based on the corresponding latitude and the corresponding longitude.

5. The method of claim 3, further comprising:
associating the plurality of waypoints with the predicted trajectory based on a unique flight number.

6. The method of claim 5, wherein the predicted path comprises a plurality of trajectory integration steps, wherein each trajectory integration step in the plurality of trajectory integration steps corresponds to a different segment in the predicted trajectory.

7. The method of claim 1, wherein the predicted trajectory data comprises a predicted ETA at a waypoint and the reference trajectory comprises an actual crossing time at the waypoint, and wherein computing the ETA error data comprises:
calculating a difference between the predicted ETA and the actual crossing time at the waypoint.

8. The method of claim 7, wherein the predicted trajectory includes the waypoint, and wherein calculating the difference further comprises:
comparing the predicted ETA at the waypoint with the actual crossing time at the waypoint, wherein the ETA error data further includes a second difference between a second predicted ETA at a second waypoint and a second actual crossing time at the second waypoint.

9. The method of claim 1, further comprising:
receiving, via the graphical user interface, a selection of a point in time of the stored flight;
generating an updated predicted trajectory, updated ETA error data, and an updated reference trajectory of the stored flight based on the selection; and
updating the graphical user interface to display the updated predicted trajectory, the updated ETA error data, and the updated reference trajectory of the stored flight.

10. An apparatus, comprising:
a memory;
a processor coupled to the memory and configured to:
receive an ETA log file, wherein the ETA log file is based on stored flight data that is associated with a stored flight, wherein the ETA log file comprises a predicted trajectory for the stored flight generated by replaying the stored flight data, and wherein the predicted trajectory includes aircraft state data and predicted trajectory data for the stored flight;
extract the aircraft state data and the flight plan data from the ETA log file, wherein the aircraft state data includes at least one of a coordinate position of the stored flight, an altitude of the stored flight, and a groundspeed of the stored flight, and wherein the flight plan data includes the predicted trajectory, wherein the predicted trajectory data comprises at least one of a predicted path, a predicted altitude, and a predicted speed of flight to a future point in the predicted trajectory;
compute ETA error data for the stored flight based on the aircraft state data, the flight plan data, and a reference trajectory of the stored flight; and
display, via a graphical user interface, the predicted trajectory, the ETA error data, and the reference trajectory of the stored flight.

11. The apparatus of claim 10, wherein the stored flight data is based on one of historical flight data that is associated with an actual flight or simulated flight data based on user-specified flight data that is associated with a simulated flight and wherein the stored flight is one of the actual flight or the simulated flight.

12. The apparatus of claim 11, wherein the ETA log file further comprises waypoint data associated with a plurality of waypoints in the predicted trajectory and wherein the waypoint data for each waypoint is represented in a coordinate format, the processor is further configured to:
convert the coordinate format into a corresponding latitude and a corresponding longitude.

13. The apparatus of claim 12, wherein the processor is further configured to:
identify a waypoint in the plurality of waypoints based on the corresponding latitude and the corresponding longitude.

14. The apparatus of claim 12, wherein the predicted path comprises a plurality of trajectory integration steps, wherein each trajectory integration step in the plurality of trajectory integration steps corresponds to a different segment in the predicted trajectory.

15. The apparatus of claim 12, wherein the processor is further configured to:
associate the plurality of waypoints with the predicted trajectory based on a unique flight number.

16. The apparatus of claim 10, wherein the predicted trajectory data comprises a predicted ETA at a waypoint and the reference trajectory comprises an actual crossing time at the waypoint, and wherein computing the ETA error data comprises:
calculating a difference between the predicted ETA and the actual crossing time at the waypoint.

17. The apparatus of claim 16, wherein calculating the difference further comprises:
comparing the predicted ETA at the waypoint with the actual crossing time at the waypoint, wherein the ETA error data further includes a second difference between a second predicted ETA at a second waypoint and a second actual ETA at the second waypoint.

18. The apparatus of claim 10, the processor further configured to:
receive, via the graphical user interface, a selection of a point in time of the simulated flight;
generate an updated predicted trajectory, an updated ETA error data, and an updated reference trajectory of the stored flight based on the selection; and
update the graphical user interface to display the updated predicted trajectory, the updated ETA error data, and the updated reference trajectory of the stored flight.

19. A non-transitory computer readable medium having instructions stored thereon that, when executed by at least one processor, cause the processor to perform operations comprising:
receive an ETA log file, wherein the ETA log file is based on stored flight data associated with a stored flight, wherein the ETA log file comprises a predicted trajectory generated by replaying the stored flight data, and wherein the predicted trajectory includes aircraft state data and predicted trajectory data for the stored flight;
extracting the aircraft state data and the flight plan data from the ETA log file, wherein the aircraft state data includes at least one of a coordinate position of the stored flight, an altitude of the simulated flight, a groundspeed of the simulated flight, and wherein the flight plan data includes the predicted trajectory;
computing ETA error data for the simulated flight based on the aircraft state data, the flight plan data, and a reference trajectory of the stored flight; and
displaying, via a graphical user interface, the predicted trajectory, the ETA error data, and the reference trajectory of the stored flight.

20. The non-transitory computer readable medium of claim 19, wherein the stored flight data is based on one of historical flight data that is associated with an actual flight or simulated flight data based on user-specified flight data that is associated with the simulated flight and wherein the stored flight is one of the actual flight or the stored flight.
